(19) United States
(12) Patent Application Publication
(10) Pub. No.: US 2002/0018444 A1
(43) Pub. Date: Feb. 14, 2002

(54) Method and apparatus for multi-lane communication channel with deskewing capability

(76) Inventors: Con D. Cremin, Cork (IE); Anne G. O'Connell, Cork (IE); John G. Ryan, Cork (IE)

Correspondence Address: Robert B. O'Rourke, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/833,541

(22) Filed: Apr. 11, 2001

Related U.S. Application Data
(60) Provisional application No. 60/196,469, filed on Apr. 11, 2000.
(60) Provisional application No. 60/197,352, filed on Apr. 13, 2000.

(51) Int. Cl. H04L 12/26

(52) U.S. Cl. 370/235; 370/412; 370/465

(57) ABSTRACT

A method is described that converts a first flow of data words into a second flow of data words. The first flow of data words has a first data rate and the second flow of data words has a second data rate. The second data rate is greater than the first data rate such that the second flow of data words under-runs. The method also includes transmitting the second flow of data words over a plurality of communication links. A data alignment data structure is transmitted over each of the communication links for each under-run.

### CLAIM OF EARLIER FILING DATE

The present application hereby claims the benefit of an earlier filed U.S. provisional application filed on Apr. 11, 2000 and provided application Ser. No. 60/196,469. The present application also hereby claims the benefit of an earlier filed U.S. provisional application filed on Apr. 13, 2000 and provided application Ser. No. 60/197,352.

### FIELD OF INVENTION

The field of invention relates to communication channels generally; and more specifically, to a multi-lane communication channel with deskewing capability.

### BACKGROUND

FIG. 1 shows a multi-lane communication channel. A multi-lane communication channel transmits data (from transmitter 101 to receiver 103) via a plurality of lanes (e.g., lanes 112₁, 112₂, 112₃, 112₄ through 112ₙ as seen in FIG. 1). According to the operation of the channel, a unit of data that is grouped together (which may also be referred to as a data word) is provided to the transmitter input 102. When the unit of grouped data is provided to the transmitter input 102, the transmitter 101 distributes the grouped input data over the lanes to the receiver 103.

For example, as seen in the embodiment of FIG. 1, an input bus is n bytes wide (which groups input data into words having a length of “n”) and there are n lanes between the transmitter 101 and receiver 103. That is, in this example, there is a lane for each byte within the input word of data. The transmitter 101 may therefore be designed to transmit, for each input word of data provided to the transmitter, the first byte 114₁ of the input word over lane 112₁; the second byte 114₂ of the input word over lane 112₂; . . . and the nth byte 114ₙ of the input word over lane 112ₙ. The receiver 103 then reassembles the data from the plurality of lanes so that each data word is provided at the receiver output 104.

Ideally, each data word that is presented at the receiver output 104 will be presented in the same order that it was originally provided at the transmitter input 102. For example, three consecutive input data words 105, 106, 107 are shown approaching the transmitter input 102 in FIG. 1. The three consecutive input data words 105, 106, 107 should then be observed identically at the receiver output 104 (after their transmission over the lanes). Skew between the various lanes 112₁ through 112ₙ, however, can jeopardize the ability to properly order the data at the receiver output 104.

Skew is the difference in arrival times, as observed at the receiver 103 over the various lanes 112₁ through 112ₙ, for data that is simultaneously transmitted from the transmitter 101. Skew arises from differences in the end to end propagation delay across each of the lanes 112₁ through 112ₙ. That is, data transmitted at the same instant upon different lanes will arrive at the receiver 103 at different times. As a result of skew, the receiver 103 can misalign the received data such that data words presented at the receiver output 104 are not identical to the data words presented at the transmitter input 102.

For example, note that FIG. 1 shows serial streams of data 108, 109, 110, 111 on lanes 112₁ through 112₄, respectively. Each first byte within these serial streams (i.e., “1” in stream 108, “2” in stream 109, etc.) was transmitted at the same instant of time from the transmitter 101 (e.g., because they belong to the same input data word such as data word 105). Note, however, that the third serial stream 110 has noticeably less propagation delay than the other serial streams 108, 109, and 111.

As a result, at time “T”, the second byte “x” in the third serial stream 110 is more closely aligned with the first byte of the other serial streams 108, 109, 111. This causes the receiver to mistakenly present the “x” byte with the other “first” bytes as seen 118 in output word 117. As a result, the receiver 103 has improperly presented a data word that is not identical to the data word originally presented to the transmitter 101.

### BRIEF DESCRIPTION OF THE DRAWINGS

The present invention is illustrated by way of example, and not limitation, in the Figures of the accompanying drawings in which:

FIG. 1 shows a multi-lane communication channel.

FIG. 2 shows an embodiment of an improved multi-lane communication channel.

FIG. 3 shows an embodiment of the clock generation unit shown in FIG. 2.

FIG. 4 shows a data alignment data structure insertion approach that may be used for data alignment of the serial data stream associated with a lane.

FIG. 5a shows an embodiment of a bit recovery unit shown in FIG. 2.

FIG. 5b shows a depiction of the oversampling performed by the bit recovery unit of FIG. 5a.

FIG. 5c shows a depiction of the eye pattern observed from the oversampling performed in FIG. 5b.

FIG. 6 shows an embodiment of the data alignment unit of FIG. 2.

FIG. 7a shows an input stream to the rotating multiplexer of FIG. 6 as provided by the bit recovery unit of FIG. 5a.

FIG. 7b shows an output stream provided by the rotating multiplexer of FIG. 6 that is in response to the input stream shown in FIG. 7a.

FIG. 8 shows an embodiment of the lane alignment unit of FIG. 2.

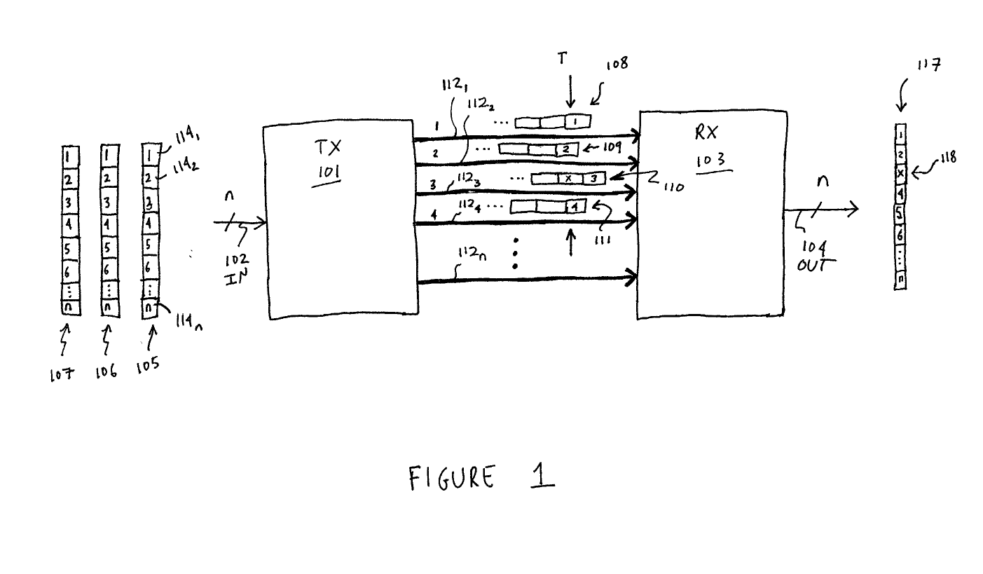

### DETAILED DESCRIPTION

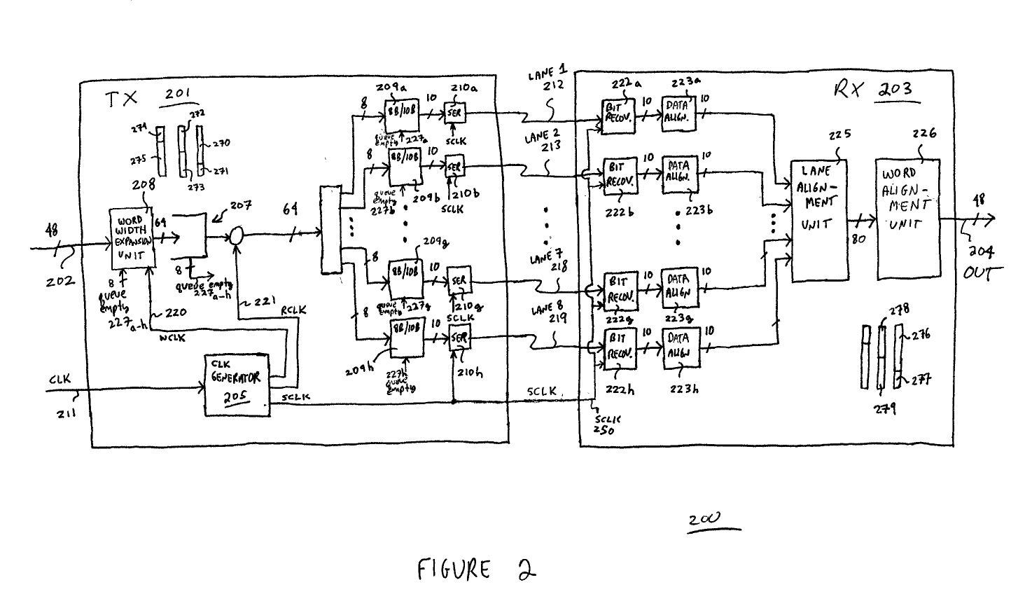

FIG. 2 shows an embodiment of a multi-lane communication channel 200 architecture that is able to properly account for skew. In the embodiment of FIG. 2, the transmitter 201 and receiver 203 are communicatively coupled by eight lanes 212 through 219. The transmitter input bus 202 and the receiver output bus 204 respectively accept and provide a 48 bit wide data word. It will be apparent to those of ordinary skill that other embodiments may exist having a different number of lanes as well as different data word widths than those observed in FIG. 2 and discussed in more detail below. As such the invention is not to be construed as limited to the specific data word lengths and/or encoding schemes discussed with respect to FIG. 2.

An overview of the data flow through the communication channel will be provided first. The overview will then be followed by a more detailed discussion of the various components of the channel architecture 200. The transmitter 201, after being provided a 48 bit input word at input 202, increases the width of the data word being processed by the communication channel to 64 bits. That is, for example, an input 202 word received at the transmitter input may be expanded by including 16 bits of the previous input word (or 16 bits of the next input word).

Input word width expansion unit 208, under maximum offered load conditions, forms a 64 bit wide word by continually mixing the content of neighboring input words. That is, a first 64 bit word (from the word width expansion unit 208) will include all 48 bits 270 of a first input word and the first 16 bits 271 of a second input word; a second 64 bit word (from the word width expansion unit 208) will include the remaining 32 bits 272 of the second input word and the first 32 bits 273 of a third input word; a third 64 bit word (from the word width expansion unit 208) will include the 16 remaining bits 274 of the third input word and all 48 bits 275 of a fourth input word. The process then repeats.

The word width expansion unit 208 may be designed to naturally craft the 64 bit words (according to the methodology described just above) by storing, within a queue 207, the segment of an input word needed to fill a 64 bit wide word slot within the queue 207. For example, if the queue is empty, all 48 bits of a first input word may be stored within a single 64 bit wide queue slot. As such, the first 16 bits of the next data word may be appended “beside” the 48 bits of the first data word within the same queue slot to form a 64 bit word. The remaining 32 bits of the next input data word may be stored in a second queue slot (allowing room for the first 32 bits of a next following input data word).

As described in more detail below, in the embodiment of FIG. 2, the speed of the clock (WCLK) that is used to time the presentation of a 48 bit word into the transmitter 201 is different than the speed of the clock (RCLK) that is used to service a 64 bit word from the queue 207. The difference in speeds allows for the insertion of a data structure with the transmitter's 201 data flow that is used for aligning data within the receiver 203 as described in more detail below.

Such a data structure may also be referred to as a data alignment data structure. Examples include a K28.5 comma character as well as other data structures that are “looked for” by a receiving device to obtain data alignment. Note that queue 207 may be formed in any of a number of different ways such as a first-in-first-out (FIFO) shift register or a memory having logic that reads and writes data from/to the memory in a manner that is consistent with the operation of a queue.

After a 64 bit word is read from the queue 207 it is fanned out in pieces to each of the eight lanes 212 through 219. That is, in the embodiment of FIG. 2, as there are eight lanes 212 through 219 and eight bytes within a 64 bit data word, each lane receives one byte of the 64 bit data word. As such, the lanes 212 through 219 are configured to simultaneously transmit a different byte from the same 64 bit data word.

A lane is a communication link. In the embodiment of FIG. 2, each lane 212 through 219 corresponds to a serial communication link (e.g., a low voltage differential signaling (LVDS) communication link, as well as others). A serial communication link transmits one bit at time as opposed to simultaneously transmitting bits in parallel. Lanes may be differential or single ended. In order to enhance the quality of the signaling over the lanes 212 through 219, each lane may be configured to encode the byte of data prior to its transmission.

Encoding schemes, such as the 8B/10B encoding scheme (which is implemented by each encoding block 209a through 209h observed in FIG. 2), typically adjusts the “balance” of the transmitted data so that the number of transmitted 1s is equal to (or approximately equal to) the number of transmitted 0s. Balancing the data in this fashion reduces or eliminates data reception disturbances (such as baseline wander) that serial communication links are susceptible to.

Other encoding schemes may be used such as 64B/66B, 4B/5B, as well as others not listed here. The 8B/10B encoding scheme converts each byte of “customer” data (from the 64 bit data word) into a 10 bit code (which may also be referred to as a “symbol”). Thus, note that the width of the data channel for each lane expands from 8 bits to 10 bits after each 8B/10B encoding block 209a through 209h. A serializer 210a through 210h converts the 10 bit symbol from its corresponding encoding block 209a through 209h into a serial data stream.

Once the encoded 64 byte word is effectively transported over the lanes 212 through 219, the receiver 203 recovers each bit from each lane via bit recovery units 222a through 222h. Each bit recovery unit 222a through 222h also deserializes the serial stream by converting the serially received data into a stream of 10 bit wide pieces of data. Data alignment units 223a through 223h determine from the stream of 10 bit wide pieces of data (that are provided by the bit recovery units), where symbols of data begin and end. That is, the data alignment units 223a through 223h effectively “mark” the stream of 10 bit wide pieces of data (from their respective bit recovery units 222a through 222h) into the 10 bit symbols originally provided by the 8B/10B encoding block 209a through 209h along their corresponding lane 212 through 219.

Note that a continuous flow of 64 bit words within the transmitter 201 will produce a continuous flow of 10 bit symbols from each of the eight lanes, after the data alignment units 223a through 223h, within the receiver 203. The lane alignment unit 225 accounts for any skew associated with this flow so that it may be properly organized back into an 8B/10B encoded flow of the 64 bit words that were originally crafted by the transmitter 201 (which corresponds to a flow of 80 bit wide words). That is, the 8B/10B encoded form of a 64 bit word corresponds to an 80 bit wide word because each encoded byte expands to 10 bits.

Within the word alignment unit 226, the 80 bit wide words provided by the lane alignment unit 225 is 8B/10B decoded causing their reduction into a flow of 64 bit wide words. Any data alignment data structures (e.g., the aforementioned k28.5 character) that were inserted by the transmitter 201 are removed and the flow of reconstructed 64 bit words are converted into the original flow of 48 bit words that were presented at the transmitter input 203 (e.g., by reversing the process performed by the word width expansion unit 208). As such, the receiver 203 is able to provide an identical flow of 48 bit words at its output 204.

Referring back to the transmitter 201, recall from above that in the embodiment of FIG. 2 the speed of the clock (WCLK) that is used to time the presentation of 48 bit words into the transmitter 201 is different than the speed of the clock (RCLK) that is used to service the flow of 64 bit words from the queue 207. The difference in clock speed and word width size corresponds to different data rates which, in turn, allows for the insertion of data alignment data structures (e.g., K28.5 characters) within the outbound data flow from the transmitter 201.

In an embodiment, the WCLK (which is provided on clock line 220) is 100 MHz and the RCLK (which is provided on clock line 221) is 80 Mhz. As such, data is clocked into the transmitter 201 at a data rate of 4.8 Gb/s (48×100E6=4.8E9) while data is clocked out of the queue 207 at a data rate of 5.12 Gb/s (64×80E6=5.12E9). This corresponds to data being provided to the lanes 212-219 at a rate that is higher than the rate at which data is provided to the transmitter 201.

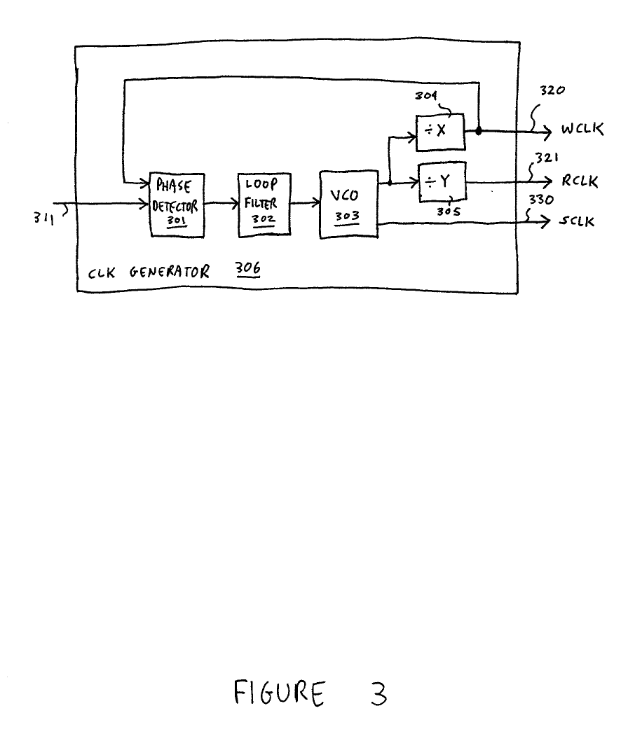

FIG. 3 shows a more detailed embodiment 305 of the clock generation unit 205 shown in FIG. 2 that provides the WCLK and RCLK clock signals. In the embodiments of FIGS. 2 and 3, the clocking rate of the input data word is provided by the user at clock input 211 and 311. In an embodiment, the clock input frequency is 100 Mhz which provides the aforementioned input data rate of 4.8 Gb/s. The clock generation circuit 305 of FIG. 3 is a phase lock loop circuit that multiplies the frequency of the input clock.

The amount of frequency multiplication is determined by the feedback division “X” performed by the feedback divider 304. For example, in the embodiment referred to above, the feedback division is 4.0. For an input clock 311 frequency of 100 MHz this corresponds to a VCO 303 output signal frequency of 400 Mhz. The feedback divider 304 also provides the 100 MHz WCLK signal at output 320. A second divider 305 forms the RCLK signal by the dividing the VCO output signal by a factor of Y. In an embodiment, Y is set equal to 5.0 so that (for a 400 MHz VCO 303 output signal frequency) an RCLK frequency of 80 MHz is crafted at output 321. The SCLK output 211 and 311 is taken from the VCO 303 to provide (at output 330) a higher speed clock signal that is used by the transmitter's serializer blocks 210ₐ through 210h to transmit serial data onto the lanes 212 through 219. The serializer blocks 210a through 210h, can in various embodiments, multiply up the frequency of the SCLK signal in order to produce the correct lane serial data rate.

In the embodiment of FIG. 2, the data rate of each lane 212 through 219 may correspond to a serial bit rate of at least 640 Mb/s (not accounting for the data expansion provided by the encoding process). Thus the combination of eight lanes 212 through 219 is able to fully service the queue output data rate (i.e., 8×640 Mb/s=5.12E9). The additional bandwidth made available by the eight lanes (with respect to the maximum load offered to the transmitter from its input 202) may be used to supply data alignment data structures used for data alignment at the receiver 203.

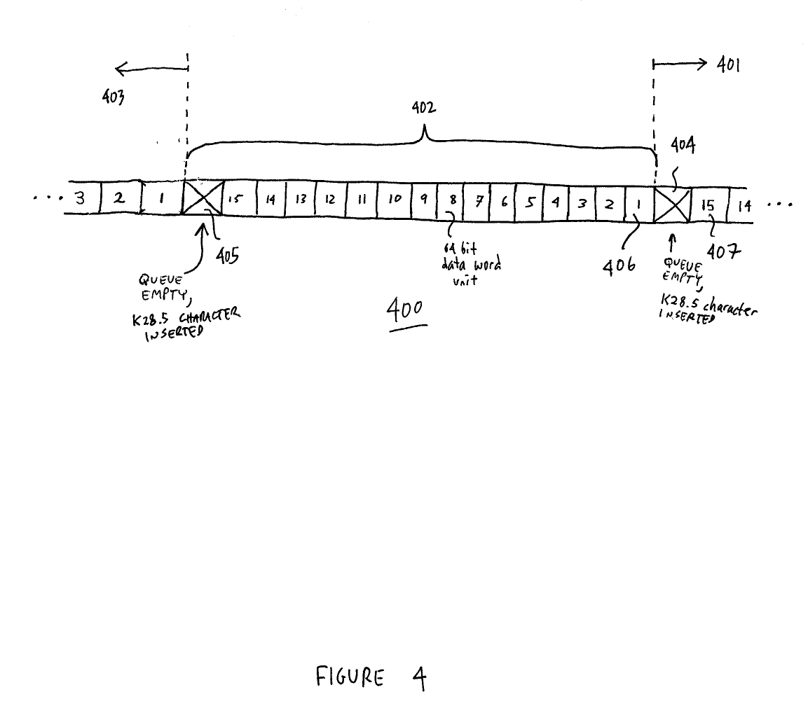

For example note that under full offered load conditions, if 64 bit words are added to the queue 207 at a data rate 4.8 Gb/s but are removed from the queue at a data rate of 5.12 Gb/s, the queue will be completely empty once for every issuance of fifteen 64 bit data words. That is, referring to FIG. 4, as 15/16 of 5.12 Gb/s is 4.8 Gb/s, the servicing of the queue may be viewed in groups 401, 402, 403 of sixteen units of 64 bit data words. Of these sixteen units per group, the input word expansion unit 208 can only provide information at a data rate sufficient to fill fifteen units. As such, the queue (or, as another perspective, the 64 bit wide data flow within the transmitter 201) becomes “empty” (i.e. “under runs”) for every “16^{th}” unit (e.g., units 404 and 405 of FIG. 4).

The transmitter 201 embodiment of FIG. 2 is designed to insert a data alignment data structure into the outbound data flow among lanes 212 through 219, whenever the queue 207 is empty. Referring to FIG. 2, note that eight “queue empty” signals 227a through 227h are generated by the queue 207. One queue empty signal is provided to a corresponding 8B/10B encoder 209a through 209h for each of the eight lanes 212 through 219. In an embodiment, when the queue 207 becomes completely empty (e.g., for each 16^{th} unit such as units 404 and 405 of FIG. 4), each “queue empty” signal 227a through 227h is asserted which, in turn, triggers the release of an encoded K28.5 character from each 8B/10B encoder 209a through 209h.

Thus, a parallel flow of eight encoded K28.5 characters (one for each lane 212 through 219) are simultaneously transmitted from the transmitter 201. Note that FIG. 4 may also be viewed as the data flow along each lane 212 through 219 where each group (e.g., groups 401, 402, and 403) corresponds to the sixteen units of 8B/10B symbols. That is, for example, data unit 406 (as well as the other fifteen data units within group 402) is a 10 bit symbol that corresponds to an encoded byte of data received by the 8B/10B encoder associated with the lane. As such, data units 404 and 405 correspond to the 10 bit encoded K28.5 character that is inserted by the 8B/10B encoder upon the assertion of the “queue empty” signal. An encoded K28.5 character is a special 10 bit character that cannot be produced by 8B/10B encoding a data byte. As such, it can be “identified” at a receiver and used to mark where the 10 bit symbols start and end. This corresponds to a form of data alignment as described in more detail below.

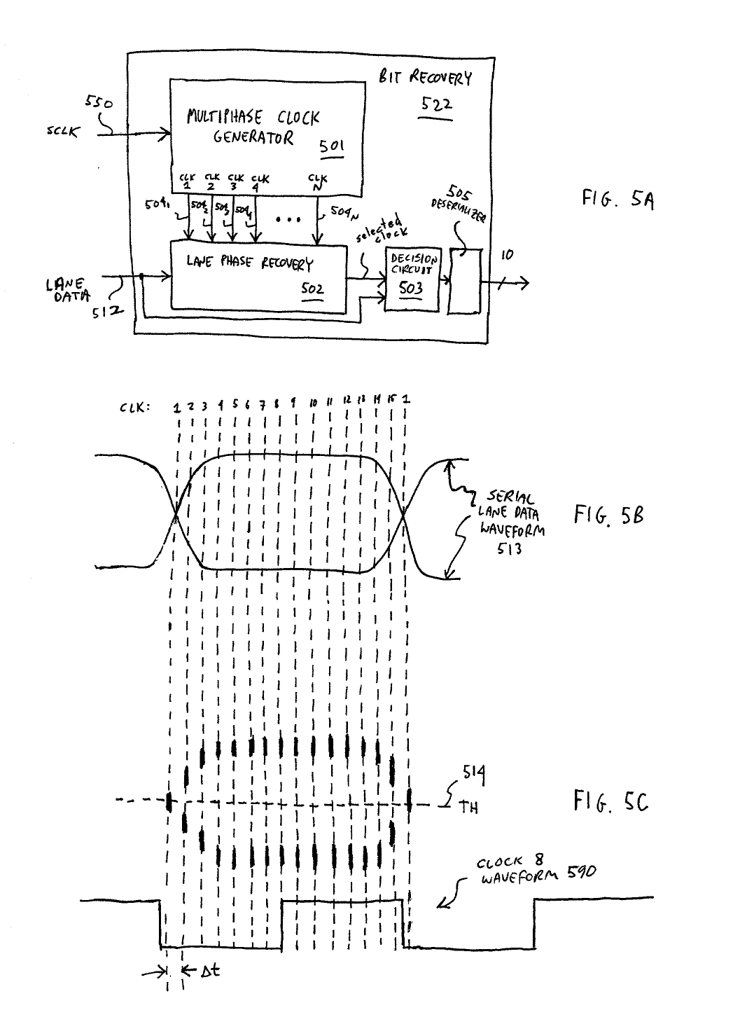

FIGS. 5a through 5c relate to the bit recovery units 222a through 222h observed within the receiver 203 of FIG. 2. FIG. 5a shows an embodiment 522 of a bit recovery unit. The serial data from a lane is received upon the lane data input line 512 and a clock from the transmitter 201 used to time the serial lane data (such as the SCLK observed in FIG. 2) is received upon the clock input 550. In an embodiment, the multiphase clock generator 501 includes a phase lock loop circuit that multiplies the frequency of the input clock (SCLK) so that it corresponds to the rate of the serial data received at input 512 (e.g., a fraction of, or equal to, the frequency of the serial data's bit rate).

In the approach of FIG. 5a, the multiplied clock signal within the multiphase clock generator 501 is used to form N clock signals 504₁ through 504_{N}. Each of the N clock signals have the same frequency but have different phase positions with respect to one another. For example, the dashed vertical lines of FIGS. 5b and 5c indicate the positions of similarly directed edges (e.g., all rising or all falling) for fifteen different clock signals provided by the multiphase clock generator (i.e., N=15).

Because of the different phase positions, the similarly directed edges of the N clocks 504₁ through 504_{N} occur at different times (e.g., each being spaced Δt apart as seen in FIGS. 5a and 5b). These edges may be used to trigger an oversampling of the lane waveform 513. That is, a sample of the lane waveform 513 is taken by the lane phase recovery unit 502 at the edges of the multiphase clocks 504₁ through 504_{N}. An exemplary depiction of the oversampling, referred to as an eye pattern, is seen in FIG. 5c.

The lane phase recovery unit 502 is designed to determine where the edges of the lane waveform 513 are located (e.g., by identifying which clock produces waveform samples closest to a midpoint threshold 514). Note that in the exemplary depiction of FIG. 5c, the edges of the lane waveform 513 are approximately aligned with clock 1. Upon determining the location of the lane data waveform edges (by identifying which clock it is aligned with), the lane phase recovery unit 502 next determines which of the N clocks should be used as a binary decision point for the lane data.

In one approach, the clock whose phase is located at (or approximately at) half a bit width beyond the phase of the clock aligned with the edges of the lane waveform 513 is selected for deciding whether or not the lane waveform corresponds to a 1 or a 0. For example, referring to the eye pattern of FIG. 5c where the edges of the lane waveform 513 are approximately aligned with clock 1, clocks 8 or 9 (i.e., the clocks nearest N/2 beyond clock 1) may be used to trigger a decision as to whether or not the lane waveform 513 corresponds to a 1 or a 0.

Thus, in summary, the lane phase recovery unit 502 may be designed to include logic that: 1) detects which of the N clocks 504₁ through 504_{N} is most aligned with the edges of the lane waveform 513; and 2) selects the clock from the multiphase clock generator 501 having a phase position that is approximately half of a bit width beyond the phase position of the clock mentioned just above. A decision circuit 503 may then be used to decide, based upon the phase position of the selected clock described just above, whether or not the lane waveform corresponds to a 1 or 0. The decision circuit 503 may also be coupled to a deserializer 505 that deserializes the serial lane data into parallel output pieces (e.g., of 10 bits as seen in FIG. 5a).

Note that the frequency of the N clocks 504₁ through 504_{N} that are provided by the multiphase comparator 501 may, in various embodiments, be equal to or a fraction of the rate at which bits arrive along the lane data input (e.g., 1/2, 1/4, 1/8, etc.). By so doing, the samples of the lane waveform 513 may be taken by the lane phase recovery unit 502 on the edges of the clock selected for sampling. For example, FIG. 5c shows the waveform 590 for clock 8 which may sample waveform 513 on each rising edge of clock 8. The various phases may be crafted by imposing a unique propagation delay for each of the N clocks 504₁ through 504_{N}.

Note that multiple bit recovery units may share the outputs of a single multiphase clock generator. For example, referring to FIG. 2 and 5a, a first bit recovery unit such as bit recovery unit 222a may correspond to the bit recovery unit design provided in FIG. 5a (which includes a multiphase clock generator 501). The remaining bit recovery units 222b through 222h within the receiver, however, need only include a lane phase recovery unit 502, decision circuit 503 and deserializer 505 because the N clocks generated from the multiphase clock generator 501 of the first bit recovery unit 222a may also be used to recover the phase alignment of the waveforms on lanes 213 through 219.

Referring to FIG. 2 note that, after bit recovery, data alignment is recovered for each of the lanes by the data alignment units 223a through 223h, respectively. Data alignment is the process by which a stream of 1s and 0s are “marked” so as to define where the symbols (or other organized structures) within the stream start and end. Recall that within the confines of 8B/10B encoding, each byte of data from the 64 bit wide word within the transmitter is converted into a 10 bit symbol.

Recall from FIG. 4 that a data alignment data structure, such as a K28.5 character, may be inserted into the flow of a lane's data by the transmitter. By looking for and identifying the arrival of a data alignment data structure, the receiver is able to understand where a symbol (or other organized structure within a stream of data) starts and ends. Being able to “align” the data follows naturally from such an understanding. For example, upon the identification of a K28.5 character 404 within a received data flow, the receiver is able to understand that either of the bits immediately outside of the detected K28.5 character correspond to the outer bits of the symbols 406, 407 that reside on either side of the K28.5 character 404. Until this detection, the flow of data is just an unstructured stream of 1s and 0s. As such, a data alignment data structure is any pattern of data that may be “looked for” within a received stream of data to gain alignment(i.e., recapture the structure) to the stream of data.

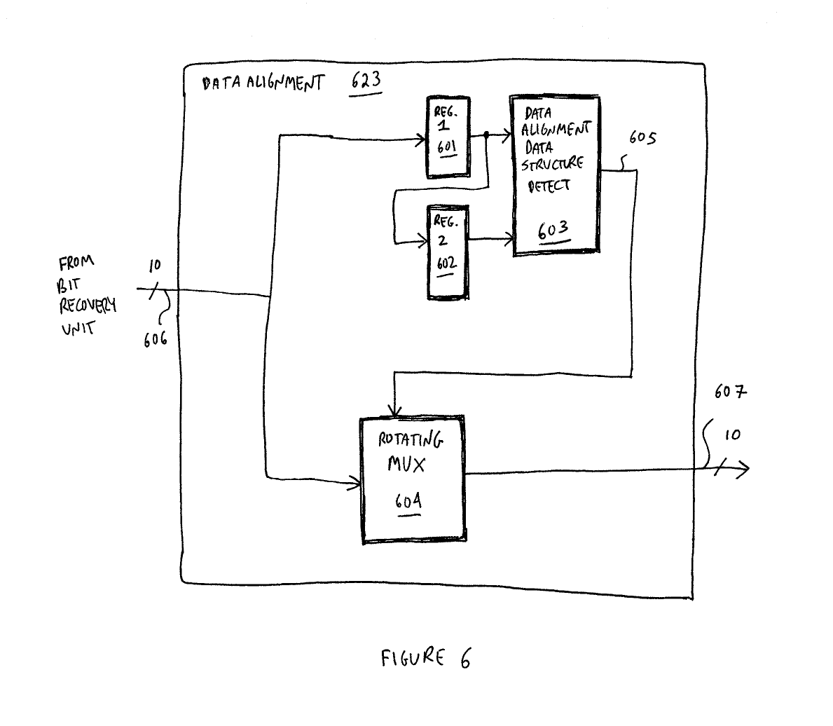

FIG. 6 shows an embodiment of a data alignment unit 623 that identifies the presence of a data alignment data structure within the 8B/10B encoded data stream that is received from a lane. In an embodiment, the data alignment unit 623 aligns data to a degree of resolution that corresponds to a symbol of information. Furthermore, in an embodiment, the data alignment data structure corresponds to a K28.5 character.

Recall that the 8B/10B encoding unit expands a byte of information into 10 bit symbols. The 8B/10B encoded K28.5 character, as discussed, corresponds to a unique pattern of 10 bits. The data alignment unit 623 of FIG. 6 effectively scans the received data flow (over a sliding 20 bit window that “slides” in 10 bit increments) for this unique pattern.

The 20 bit window is obtained by operation of a pair of 10 bit registers 601, 602. Recalling that the deserializer 505 within the bit recovery unit 522 of FIG. 5a may be configured to deserialize the data flow into a stream of 10 bit pieces of data, each 10 bit piece of data provided from the bit recovery unit (along input 606) is latched into a first register 601; and, the previous 10 bit word provided by the bit recovery unit is latched into the second register 602.

According to one approach, the data alignment data structure detect circuit 603 screens the received data flow in search of the unique 10 bit pattern that corresponds to the encoded K28.5 character. Note that the shifting of the contents of the 10 bit wide registers 601, 602 corresponds to sliding a 20 bit window in 10 bit increments. Upon the arrival of the sought for 10 bit pattern, it will appear somewhere within the 20 bit window formed by registers 601, 602. The data alignment data structure detect circuit 603 is designed to identify the presence of the sought for pattern within the 20 bit register space formed by registers 601 and 602.

Before continuing it is important to note that the approach described just above is not to be construed as limited to 8B/10B encoding or 20 bit windows that slide in 10 bit increments. In general, the received data flow should be viewed over a window size that is sufficient to encompass the pattern being searched for. The resolution of the sliding of the window (e.g., 1 bit, 10 bits, etc.) may also vary with designer preference. Having a resolution that is one half the window size where the window size is twice the size of the pattern being sought, is apt to be a suitable approach in many applications.

As soon as the sought for data alignment data structure fully appears within the combined register space of registers 601, 602, at least a portion of the pattern will appear in register 601. As such, the data alignment data structure detect circuit 603 is able to identify the proper alignment marking upon the most recent 10 bit piece of data provided by the bit recovery unit. By presenting an indication of this marking to a rotating multiplexer 604, the data alignment unit 623 is able to form properly aligned data (in this case, symbols) from the data alignment unit input 606.

The rotating multiplexer 604 allows a first portion of the most recent bit recovery unit output data piece (as observed at the data alignment input 606) to be forwarded to the data alignment unit output 607.

This first portion of the most recent bit recovery unit output data piece is combined with a first portion of the immediately previous bit recovery unit output piece such that a properly aligned word appears at the data alignment output 607. The second, remaining portion of the most recent bit recovery unit output piece that is not initially forwarded to the data alignment unit output 607 is stored within the rotating multiplexer (e.g., with a register). As such, the rotating multiplexer 604 is divided as to its treatment of a newly issued piece of 10 bit data from the bit recovery unit.

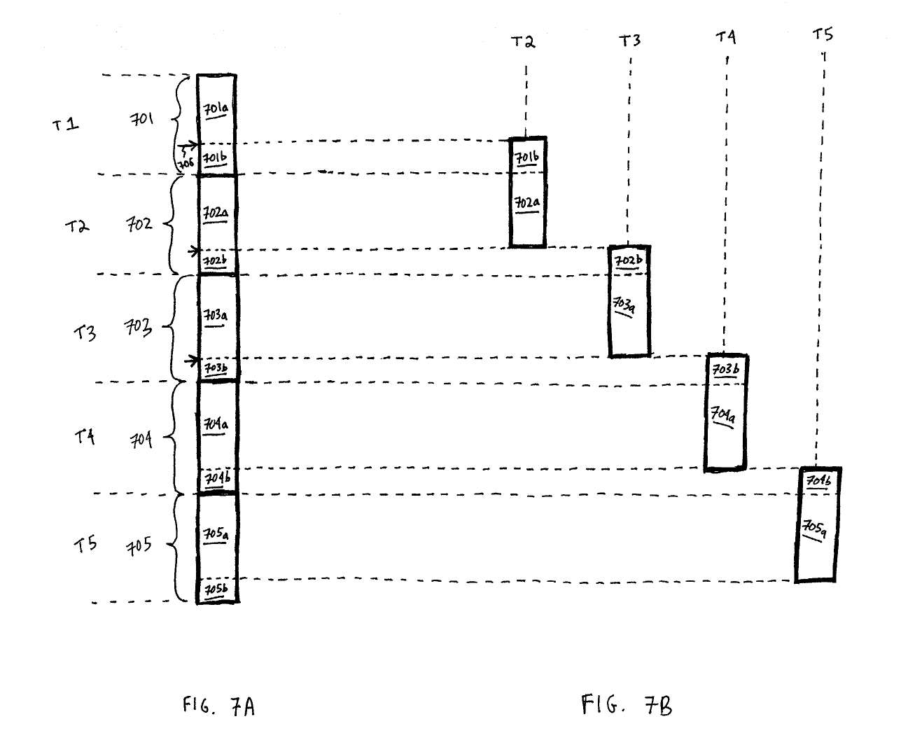

A first portion may be directly forwarded to the data alignment unit output 607 while a second portion may be stored (e.g., with a resister within rotating multiplexer 604) for delivery to the data alignment unit output 607 upon the issuance of the next issued 10 bit data piece from the bit recovery unit. The division line that defines these two portions is provided by the data alignment data structure detect circuit 603. FIGS. 7a and 7b demonstrate this cooperative operation of the rotating multiplexer 604 and the indication provided by the data alignment data structure detect circuit 603. FIG. 7a represents the flow of 10 bit data pieces presented to the data alignment unit input 606 while FIG. 7b represents the flow of 10 bit symbols presented at the data alignment output 607 (neglecting, for simplicity, latencies associated with register read/write times within the rotating multiplexer 604). Upon the detection of the data alignment data structure, the data alignment data structure detect circuit 603 indicates the position of its trailing edge (within register 601) to the rotating multiplexer 604.

Referring to FIG. 7a, assume data structure 701 corresponds to the most recent data 10 bit piece of data issued (as of time T1) by the bit recovery unit. The indication provided by the data alignment data structure detection circuit 603 effectively corresponds to a pointer 706 that points to the trailing edge of the data alignment data structure. That is region 701 a corresponds to a trailing portion of the data alignment data structure while region 701b corresponds to a leading portion of the next 10 bit symbol of data that follows the data alignment data structure (within the flow of data being transported by the lane).

Upon the receipt of this indication, the rotating multiplexer stores the region 701b of data piece 701 “below” (i.e., after) the pointer 706. At time T2, the next data piece 702 is issued by the bit recovery unit (and it appears at the data alignment unit input 606). With the pointer fixed in the same position, the rotating multiplexer forwards to the data alignment unit output (as seen in FIG. 7b): 1) the portion 701b stored from the previous data piece 701; and 2) the portion 702a from the most recent data piece 702 that is “above” (i.e., before) the pointer. The portion 702b of the most recent data piece 702 that is below the pointer is saved by the rotating multiplexer so as to replace the data that represents region 701b.

At time T3, the next data piece 703 is issued by the bit recovery unit. With the pointer fixed in the same position, the rotating multiplexer forwards to the data alignment unit output (as seen in FIG. 7b): 1) the portion 702b stored from the previous data piece 702; and 2) the portion 703a from the most recent data piece 703 that is “above” (i.e., before) the pointer. The portion 703b of the most recent data piece 703 that is below the pointer is saved by the multiplexer so as to replace the data that represents region 702b. The process repeats as seen in FIGS. 7a and 7b.

Thus, to review a first portion of the most recent bit recovery unit output data piece (i.e., regions 702a, 703a, 704a, 705a at times T2, T3, T4 and T5 respectively) is combined with a first portion of the immediately previous bit recovery unit output data piece (i.e. regions 701b, 702b, 703b, 704b at times T2, T3, T4 and T5 respectively) such that a properly aligned symbol appears at the byte alignment output 607. Note that regions 701b, 702b, 703b, 704b may be viewed as leading portions of each properly aligned symbol while regions 702a, 703a, 704a, 705a may be viewed as trailing portions of each properly aligned symbol.

Referring to FIG. 2, note that after the data alignment units 223a through 223h have issued their corresponding, properly aligned output symbols; streams of properly aligned 10 bit output symbols from each of the eight lanes are provided to the lane alignment unit 225. The lane alignment 225 unit then removes any skew that may exist on lanes 212 through 219.

Note, however, that the data alignment approach discussed above automatically eliminates any skew within 10 bit spaces (i.e., +/−5 bit spaces) of the encoded symbols that are actually passed along the various lanes. That is, referring again to FIGS. 7a and 7b, skew amongst the various lanes will be reproduced as different pointer 706 positions within the data alignment units that service the various lanes. For example, if a first lane has less propagation delay than a second lane, the corresponding bits of a pair of encoded words that are simultaneously transmitted on each lane will be received at the first lane before they are received at the second lane.

As such, the trailing edge of the data alignment data structure will be received by the first lane before it is received by the second lane. Provided the skew is less than +/−5 bit lengths on the lane (for 8B/10B applications), this only corresponds to a smaller trailing edge portion 701a for the first lane than for the second lane. That is, the pointer 706 position for the first lane will be “higher” in FIG. 7a than the pointer position 706 for the second lane. As long as some leading edge portion 701b of the data word that follows the data alignment data structure appears at time T1 within data word 701, the full data word for both lanes will be fully provided at time T2. By definition then, any amount of skew between the lanes within +/−5 bit spacings will have been effectively eliminated.

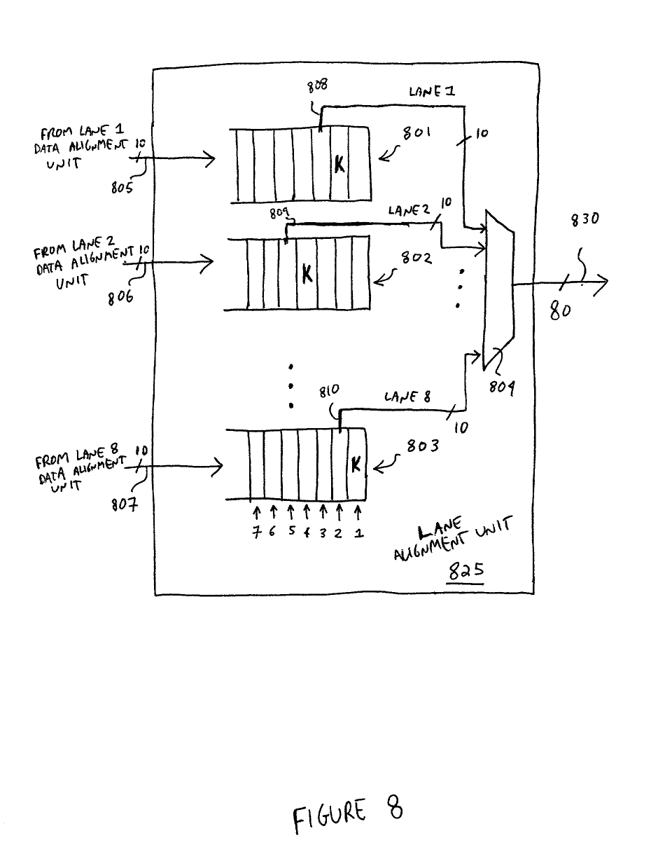

FIG. 8 shows an architecture for a lane alignment 825 (that may be viewed as corresponding to lane alignment unit 225 of FIG. 2) that provides for skew elimination for skew beyond +/−5 encoded bits upon the lanes. In the architecture of FIG. 8, each lane is provided a first in first out (FIFO) queue (such as queues 801, 802 and 803). The flow of 10 bit symbols from each lane are stored in their respective queue. Here, by looking for (and identifying) the data alignment data structure (e.g., the K28.5 character) within each data flow, skew may be canceled by selectively setting the tail pointer of each queue (e.g., tail pointers 808, 809, 810) to the queue slot immediately following the data alignment data structure.

A tail pointer (which may also be referred to as an issue pointer) points to the queue slot from which 10 bit symbols are removed from the queue in order to implement queue servicing. In FIG. 8, the location of the data alignment data structure is indicated by a “K”. Note that, as result of skew beyond +/−5 encoded data bits on the lanes, the data structures are not perfectly aligned with one another across all the queues (because they each have a different “arrival time” at the receiver beyond +/−5 encoded bits). However, by setting the tail pointers (e.g., tail pointers 808, 809, 810) as shown, the skew is automatically eliminated. As such, a flow of 80 bit wide words that corresponds to the 8B/10B encoded form of the flow of 64 bit wide words originally crafted by the transmitter is created and presented upon the lane alignment unit output 830.

Referring back to FIG. 2, the word alignment unit 226 removes the data alignment data structures inserted into the data flow by the transmitter 201 and re-formats the 80 bit words into 48 bit words in a manner that corresponds to the reverse of that described with respect to the input word expansion unit 208. As such, a stream of 48 bit words are provided at the receiver output 204 that are identical to the stream of 48 bit words originally presented to the transmitter input 202. Recall that the word width expansion unit 208 of FIG. 2 may be configured to construct 64 bit words by combining portions of neighboring 48 bit input words together. That is, a first 64 bit word (from the word width expansion unit 208) will include all 48 bits 270 of a first input word and the first 16 bits 271 of a second input word; a second 64 bit word (from the word width expansion unit 208) will include the remaining 32 bits 272 of the second input word and the first 32 bits 273 of a third input word; a third 64 bit word (from the word width expansion unit 208) will include the 16 remaining bits 274 of the third input word and all 48 bits 275 of a fourth input word. The process then repeats.

The word alignment unit 226 effectively reverses the mixing of the neighboring input data words that was originally performed by the word width expansion unit 208 within the transmitter 201. Specifically, for example, if a 64 bit word provided to the word alignment unit 226 comprises a first 48 bit input word (as originally provided to transmitter 201) plus 16 bits of a following second 48 bit input word (as originally provided to transmitter 201), the word alignment unit 226 will provide at output 204 the first 48 bit word (as originally provided to transmitter 201) followed by a second 48 bit word that compromises the 16 bits described just above.

By understanding the operation of the transmitter 201, the word alignment unit 226 can be designed to successfully delineate the flow of 80 bit wide words it receives from the lane alignment unit 225 into the appropriate 48 bit words for presentation at output 204. This flow of 80 bit wide words, under full loading conditions, corresponds to the 8B/10B encoded form of the of 64 bit words originally crafted by the data word expansion unit 208 with an inserted 80 bit word flow of encoded K28.5 characters for each queue 207 under-run condition.

In an embodiment, the word alignment unit 226 removes any encoded K28.5 characters so that the 8B/10B encoded form of the flow of 64 bit words originally crafted by the data word expansion unit 208 can be isolated. In an embodiment, the word width expansion unit 208 is designed such that the first 64 bit word to enter the queue 207 after a queue under-run condition comprises a full 48 bit input word 270 and the first 16 bits 271 of the following 48 bit input word.

As such, the word alignment unit 226 can be designed to form a 48 bit output word (for presentation at output 204) by selecting and 8B/10B decoding the first 60 bits 276 of any 80 bit wide word that immediately follows an 80 bit word of encoded K28.5 characters (i.e., an encoded 8xK28.5 data word). This will automatically produce the full 48 bit input word 270 that was included in the first 64 bit word to be entered in the queue 207 after a queue under-run condition.

This effectively allows the word alignment unit 226 to perform word alignment. That is, by understanding that a “next” output word corresponds to the first 60 bits 276 of an 80 bit word that immediately follows any encoded 8xK28.5 data word, the word alignment unit 226 is able to calculate and “mark” where subsequent output words are located in the following flow of 80 bit wide words. As such, the word alignment unit 226 is able to correctly provide a stream of 48 bit output words at output 204 that is identical to the stream of 48 bit input words initially provided at the transmitter input 202.

For example, as the first 60 bits 276 of the 80 bit word immediately following a 8xK28.5 data word corresponds to the “next” 48 bit output word, the remaining 20 bits 277 of this 80 bit word as well as the first 40 bits 278 of the following 80 bit word corresponds to the 8B/10B encoding of the following 48 bit output word. As such, 8B/10B decoding of this data 277, 278 will automatically produce the following 48 bit output word. Subsequent output words can be similarly marked.

Note that in the embodiment of FIG. 2, each lane's corresponding 8B/10B encoder 209a through 209h has its own unique “queue empty” signal 227a through 227h. When the queue 207 is completely empty, each of these signals 227a through 227h are asserted in unison to simultaneously trigger the release of an encoded K28.5 character along each lane 212 through 219.

In less than full load circumstances, the individual “queue empty” signals 227a through 227h may be individually modulated to “stuff” the lanes with K28.5 characters so that, for example, only one 48 bit input word can be transmitted over the eight lanes 212 through 219 (without 16 bits of a neighboring input word). For example, the first six lanes 212 through 217 may be used to transport the 60 bits associated with an 8B/10B encoded 48 bit word while the “queue empty” signals 227g and 227h are asserted to trigger a K28.5 character along lanes 218 and 219. The word alignment unit 226, as discussed, discards the K28.5 characters so that the 48 bit word can be recovered.

In an alternate embodiment of the word width expansion unit 208, the word width expansion unit 208 is designed to include 8B/10B encoding. As a result, the 8B/10B encoders 209a through 209h may be removed from the depiction of FIG. 2. Furthermore, a single “queue empty” signal is all that may be provided from the queue 207 to indicate when the queue reaches an underrun condition. The word width expansion unit 208 (or another, separate circuit not shown in FIG. 2 for simplicity) can incorporate encoded K28.5 characters into the flow of data words (e.g., by insertion into the queue 207 directly) in response to a queue empty signal (or to “stuff” individual lanes as mentioned above in less than full loading conditions). Furthermore, note that the width of the queue 207 expands to 80 words (from 64) to account for the 8B/10B encoding.

It is important to once again point out that the particular word width sizes, data rates, and number of communication links may vary from embodiment to embodiment. For example, as just one variation, word width size may be compressed (rather than expanded) within the transmitter. The number of corresponding communication links may be reduced in response. Provided the combined data rate over the links exceeds the input word data rate, data alignment data structures may still provided in the compressed data word flow for each under-run condition.

Note also that embodiments of the present description may be implemented not only within a semiconductor chip but also within machine readable media. For example, the designs discussed above may be stored upon and/or embedded within machine readable media associated with a design tool used for designing semiconductor devices. Examples include a netlist formatted in the VHSIC Hardware Description Language (VHDL) language, Verilog language or SPICE language. Some netlist examples include: a behaviorial level netlist, a register transfer level (RTL) netlist, a gate level netlist and a transistor level netlist. Machine readable media also include media having layout information such as a GDS-II file. Furthermore, netlist files or other machine readable media for semiconductor chip design may be used in a simulation environment to perform the methods of the teachings described above.

Thus, it is also to be understood that embodiments of this invention may be used as or to support a software program executed upon some form of processing core (such as the CPU of a computer) or otherwise implemented or realized upon or within a machine readable medium. A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
a) converting a first flow of data words into a second flow of data words, said first flow of data words having a first data rate, said second flow of data words having a second data rate, said second data rate greater than said first data rate such that said second flow of data words under-runs; and
b) transmitting said second flow of data words over a plurality of communication links, a data alignment data structure transmitted over each of said communication links for each said under-run.

2. The method of claim 1 wherein said converting further comprises expanding said first flow of data words into said second flow of data words by combining a first data word of said first flow of data words with at least a portion of a second data word of said first flow of data words such that said second flow of data words is wider than said first flow of data words.

3. The method of claim 1 further comprising encoding data within either said first flow of data words or said second flow data words, said encoding for reliable transmission over said plurality of communication links.

4. The method of claim 3 wherein said encoding further comprises 8B/10B encoding.

5. The method of claim 4 wherein said data alignment data structure is a K28.5 character.

6. The method of claim 1 wherein each of said plurality of communication links corresponds to an LVDS communication link.

7. The method of claim 1 further comprising receiving a stream of data from each of said plurality of communication links.

8. The method of claim 7 further comprising obtaining data alignment on each of said streams of data by identifying an appearance of a said data alignment data structure within each of said streams of data.

9. The method of claim 7 further comprising obtaining lane alignment to remove skew as between each of said streams of data by aligning said streams of data, with respect to each another, according to their data alignment data structure arrival time, said aligning causing a formation of a third flow of data words that corresponds to a reproduction of said second flow of data words.

10. The method of claim 9 wherein said third flow of data words is an encoded form of said second flow of data words.

11. The method of claim 9 further comprising reversing said converting in order to reproduce said first flow of data words from said third flow of data words.

12. The method of claim 11 further comprising removing any said data alignment data structures found within said third flow of data words during said reversing.

13. The method of claim 11 further comprising decoding said third flow of data words during said reversing.

14. An apparatus, comprising:
a transmitter that expands a flow of input data words into a second flow of data words, said flow of input data words having a first data rate, said second flow of data words having a second data rate, said second data rate greater than said first data rate such that said second flow of data words under-runs, said transmitter having a plurality of communication links that each transmit:
1) a different piece of said second flow of data words; and
2) a data alignment data structure for each said under-run.

15. The apparatus of claim 14 further comprising an encoder that encodes data within either said first flow of data words or said second flow data words, said encoding for reliable transmission over said plurality of communication links.

16. The apparatus of claim 15 wherein said encoder further comprises an 8B/10B encoder.

17. The apparatus of claim 16 wherein said data alignment data structure is a K28.5 character.

18. The apparatus of claim 14 wherein each of said plurality of communication links corresponds to an LVDS communication link.

19. The apparatus of claim 14 further comprising a receiver that receives a stream of data from each of said plurality of communication links.

20. The apparatus of claim 19 wherein said receiver further comprises, for each of said communication links, a data alignment unit that obtains data alignment on each of said streams of data by identifying an appearance of a said data alignment data structure within each of said streams of data.

21. The apparatus of claim 19 wherein said receiver further comprises a lane alignment unit that removes skew as between each of said streams of data by aligning said streams of data, with respect to each another, according to their data alignment data structure arrival time, said aligning causing a formation of a third flow of data words that corresponds to a reproduction of said second flow of data words.

22. The apparatus of claim 21 wherein said third flow of data words is an encoded form of said second flow of data words.

23. The apparatus of claim 21 wherein said receiver further comprises a word alignment data unit that reproduces said first flow of data words from said third flow of data words by reversing said converting.

24. The apparatus of claim 23 wherein said word alignment data unit, during said reversing, removes any said data alignment data structures found within said third flow of data words.

25. The apparatus of claim 24 wherein said word alignment data unit further comprises a decoder that decodes said third flow of data words during said reversing.

26. An apparatus, comprising:
a) a word width expansion unit that expands a flow of input of data words into a second flow of data words, said flow of input data words having a first width and a first data rate, said second flow of data words having a second width, said second width greater than said first width;
b) a queue that receives said second flow of data words and services said second flow of data words from said queue according to a second data rate, said second data rate greater than said first data rate such that said queue under-runs;
c) a plurality of transmission links that transmit different pieces of said serviced second flow of data words and transmit a data alignment data structure for each of said queue under-runs.

27. A method, comprising:
a) receiving a first and second data word according to a first data rate;
b) entering a third data word into a queue, said third data word a combination of said first data word and at least a portion of said second data word;
c) servicing said third data word from said queue according to a second data rate, said second data rate higher than said first data rate such that said queue under runs;
d) fanning out said third data word into a plurality of pieces;
e) transmitting each of said pieces over a different communication link; and
f) transmitting a data alignment data structure over each of said communication links whenever said queue under runs.
